(19) United States
(12) Patent Application Publication
(10) Pub. No.: US 2010/0208546 A1
(43) Pub. Date: Aug. 19, 2010

(54) Activation device

(76) Inventors: Jere Ferguson, Lutz, FL (US); Tohi W. Ferguson, Lutz, FL (US); Raquel Carvallo, Tampa, FL (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 12/378,728

(22) Filed: Feb. 19, 2009

(51) Int. Cl. B01F 13/06

(52) U.S. Cl. 366/139

(57) ABSTRACT

A device for activating a two component reaction system where the two reaction component are in separate containers with one container inside the other. A pressure differential between the pressure in the inner and outer containers is made so the inner container has the higher pressure. The inner container has a line around at least one part of the inner container and extends through the outer container. The line is aligned to tear the container when it is pulled.

### BACKGROUND

This invention relates to an activation device for activating a two component reaction system where the two reaction component are in separate containers with one container inside the other. An example of such a reaction system is a system for heaters of personal hygiene wipes or cloths used to cleanse various parts of the body. More particularly, the invention relates to an improved activation device package for a personal hygiene wipe or cloth that is temperature controlled to give increased comfort and utility.

Personal hygiene wipes are often used by persons when they are away from their home and do not have access to a shower or bath. They are also used when the part of the person that is to be cleaned is small, and a shower or bath consumes too much time.

In order to be effective, however, personal hygiene wipes need to be warmed or heating in order to more effectively clean the hands or other parts of the user's anatomy. At the present time, warm wipes are only attainable by the use of an external source of hot water, or by inserting the wipes into a microwave or other heating device. This presents a danger as the degree of heating may vary, and it is possible to have excessive heat applied to the skin.

A major drawback of the use of an exothermic reaction to generate heat upon demand is that the various components have to be kept totally separated from each other until they are combined, and when combined need to react quickly and over a reasonable surface area. If the reaction only takes place at one location, excessive heat will be generated. If the reaction components are spread out, there has not been any way to combine them from the dispersed locations to generate uniform exothermic reaction. The problem that occurs is that the heater gives too much heat to part of the object to be heated and too little to other parts.

Yet another drawback to chemical generation of heat is that the reaction depends on adequate mixing that does not happen quickly enough to be useful.

It would be a great advantage if a way of bringing a two component reaction system together to react in a quick and effective manner.

Another advantage would be to provide a way of bringing a two component reaction system together that is controlled and requires a specific action by the user such that the action is not one experienced by the system when carried about prior to use.

Yet another advantage would be to provide a way to activate a heater to generate heat by an exothermic reaction over a personal hygiene wipe sized area quickly, without having to wait for an activation agent to make its way to all the reaction components.

Other advantages will appear hereinafter.

### SUMMARY

It has now been discovered that the above and other advantages of the present invention may be accomplished in the following manner. The unique aspect of this invention is the placement of one reaction component of a two component reaction system inside one container and the second reaction component inside a second container that is inside the first container. An actuation device is provided to open the inner container so the reaction can be effectively activated in a simple manner. Specifically, the activation device comprises a line or cord on the inner container that extends through the outer container, whereby pulling on the line causes the line to open the inner container. In a preferred embodiment, the inner container is made of a foil type material that is torn by pulling on the line.

The invention uses a two component activation device such as those used for a heater in a package holding personal hygiene wipes. Other two component reaction systems, such as, by way of example and not by way of limitation, are systems where the reaction absorbs heat or effectively provides a cooling effect. Another example of a two component system is one that keeps an adhesive such as an epoxy resin separate from the catalyst that causes it to react until the time for bonding something is at hand. Cosmetics, edible products, medicines and diet supplements are other examples of products that it may be desirable to mix quickly, particularly mixing a solid and a liquid.

The device of this invention allows the activation of the reaction when the user decides the time has come to do so. There is, in the preferred embodiment, a pressure differential between the outer container at a lower pressure than the inner container so that the reaction agent is thrust out of the inner container into contact with the reaction component inside the outer container. The outer container may have an internal vacuum sufficient to pull the activation agent into the outer container upon opening said seal. Alternatively, the inner container may have a pressure above atmospheric pressure to accomplish the same rapid mixing.

### BRIEF DESCRIPTION OF THE DRAWINGS

FIG. 1 is a perspective view of the device of this invention.

### DETAILED DESCRIPTION

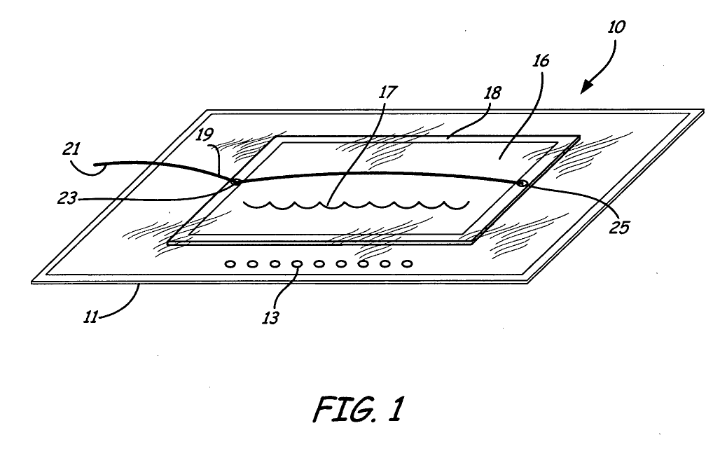

The device of this invention, 10 generally, is shown in FIG. 1 and includes an outer container 11 having a first reaction component 13 therein. Also inside the outer container 11 is inner container 16 having a second reaction component 17 therein. Part of the inner container 16 is an activation element 27, described in more detail below. In order to have an uniform and even mixing of the two reaction components, it is preferred that the inside of inner pouch 23 be at atmospheric pressure or 14.7 psi, and the inside of the outer pouch 19 be under vacuum. Preferred pressures in outside pouch 19 are from about 8 psi to about 13 psi, with 10 or 11 psi being preferred. It is necessary to have a pressure differential between the inside of both pouches to be sufficient to pull the activating agent 25 to the entire area where the heat generating material 21 has been placed. Alternatively, the inner pouch can have an increased pressure of from about 17 to 22 psi, and preferably from about 19 to 20 psi. Too little or too great a pressure differential is not desired, for design and reliability reasons.

Attached to the inner container 16 is a line 19. Line 19 can be any size or shape as long as it is capable of causing the inner container 16 to tear open when the end 21 of line 19 is pulled. In a preferred embodiment, inner container 16 is made from a heat stamp foil that is moisture impervious and that tears or rips when the line 19 is pulled.

Preferred is an outer pouch 11 made from Aclar®, which is a polychlorotrifluoroethylene (PCTFE) material manufactured and sold by Honeywell International Inc. Aclar film is crystal clear, biochemically inert, chemical-resistant, nonflammable, and plasticizer- and stabilizer-free. Aclar laminates provide a wide range of gauges and thus barrier levels to allow flexibility in selecting the optimum barrier level for the chemical system chosen. Other similar pouch materials may be used as well. All that is required is that the material have a functional moisture and vapor barrier for the other components of the invention.

The preferred embodiment is shown in FIG. 1, where line 19 encircles inner container 16 and also passes through the periphery 18 thereof. Periphery 18 is not in communication with the contents of container 16. Periphery 18 includes holes 23 and 25, which do not disturb the contents 17. Line 19 has been looped completely around container 16, back through hole 23 and out to end 21. Pulling on end 21 of line 19 causes the loop portion of line 19 to tighten and tear inner container 16, thus activating the reaction between reaction components 13 and 17. This reaction is accelerated by the vacuum inside container 11.

There are a number of combinations of heat generating materials and activating agents that are suitable for use in the present invention. The selection of specific components is to be based upon cost, compatibility, ease of control of the exotherm, and other factors.

The preferred activating material of this invention is water. This is plentiful and safe, and reacts with a number of materials to produce an exothermic reaction.

The preferred heat generating material is a crystal that, when free from moisture, is stable for up to three to five years or more, and which react when moisture is present to generate heat. The preferred crystal is made from crystalline calcium oxide. Calcium oxide is commercially available from a number of sources, one of which being Calcium Oxide Fisher Scientific S79946. For efficient integration of this component into the fabric, the calcium oxide is ground into small particles or crystals and a sieve is used to insure uniform particle size.

The weight of the heat generating material to the volume of actuation agent ranges from about 1:2 to about 1:1, and preferably about 3:4. In the most preferred mixture of the heat generating material is a mixture of calcium oxide and citric acid with the further addition of a zeolite powder. Preferred is a ratio of calcium oxide to citric acid to powdered zeolite is from about 14 to 20 for calcium oxide, from about 1 to 2 for citric acid, and from about 7 to 10 for powdered zeolite. Most preferred is a ratio of calcium oxide to citric acid to powdered zeolite is 17:1.5:8.5 and the ratio of the solids to the volume of water is about 3:4.

More than 150 zeolite types have been synthesized and 48 naturally occurring zeolites are known. They are basically hydrated alumino-silicate minerals with an “open” structure that can accommodate a wide variety of positive ions, such as Na+, K+, Ca₂+, Mg₂+ and others. These positive ions are rather loosely held and can readily be exchanged for others in a contact solution. Some of the more common mineral zeolites are: analcime, chabazite, heulandite, natrolite, phillipsite, and stilbite. An example mineral formula is: Na₂Al₂Si₃O₁₀-16H₂₀.

In order to have an uniform and even production of heat from the exotherms, it is preferred that the inside of inner pouch 16 be at atmospheric pressure or 14.7 psi, and the inside of the outer pouch 11 be under vacuum. Preferred pressures in outside pouch 11 are from about 8 psi to about 13 psi, with 10 or 11 psi being preferred. It is necessary to have a pressure differential between the inside of both pouches to be sufficient to pull the activating agent 17 to the entire area where the heat generating material 17 has been placed. Too little or too great a pressure differential is not desired, for design and reliability reasons.

In a series of tests of the preferred embodiment as described above using water to react with calcium oxide, 100% of the activations by bending the packages resulted in warm personal hygiene wipes. Then a similar set of packages were prepared, with the only change being no vacuum inside the outer pouch, only 30% of the wipes achieved the desired temperature,

It is also an embodiment of the present invention to employ a temperature changing chemical that causes a drop in temperature when contacted by water, creating an endothermic reaction. The solid materials may, for example, include materials such as sodium sulfate* 10H₂O; sodium bicarbonate, ammonium nitrate, ammonium chloride, urea, ammonium dichromate, citric acid, potassium perchlorate, potassium sulfate, potassium chloride, calcium nitrate, and vanillin. These solid compounds react with water in an endothermic fashion to impart cooling. Reactions can be with water based mixtures as well as other liquid systems. Other uses of the activation of a two component reaction system

Although the present invention has been described with reference to preferred embodiments, workers skilled in the art will recognize that changes may be made in form and detail without departing from the spirit and scope of the invention.

1. A device for activating a two component reaction system, comprising:
a first container having a first reaction component therein;
a second container having a second reaction component therein, the second container being positioned inside the first container, the second container being sealed from the first container, the second container having a line around a portion thereof and a pull end extending outside the first container, whereby tension on the pull end is adapted to open that portion of the second container to permit the second reaction component to enter the first container; and
a pressure differential between the pressure in the second container and the first container such that the second container has a higher pressure that the first container, whereby, upon opening the second reaction component in the inner pouch, the second component is driven into the outer pouch to react with the first reaction component.

2. The device of claim 1, wherein the pressure differential is caused by a vacuum inside the first container.

3. The device of claim 2, wherein the amount of vacuum in the first container is sufficient to give a pressure of from about 8 to 13 psi.

4. The device of claim 1, wherein the pressure differential is caused by an elevated pressure inside the second container.

5. The device of claim 1, wherein the second container is formed from a material capable of being torn by pressure of the line on the material.

6. The device of claim 5, wherein the material is a foil type material.

7. The device of claim 1, wherein the second container has a periphery extending out from the container and not in communication with the contents of the second container, the periphery including at least one perforation through which the line is placed such that pulling on the pull end causes the line to penetrate the container.

8. The device of claim 1, wherein the actuation agent is water and the heat generating material is crystalline calcium oxide.

9. The device of claim 8, which further includes powdered zeolite admixed therein with the calcium oxide.

10. The device of claim 9, wherein the ratio of calcium oxide to powdered zeolite is 2:1 and the ratio of the solids to the volume of water is about 3:4.

11. A method for activating a two component reaction system, comprising:
providing a first container having a first reaction component therein;
providing a second container having a second reaction component therein inside the first container, the second container being sealed from the first container, the second container having a line around a portion thereof and a pull end extending outside the first container;
providing a pressure differential between the pressure in the second container and the first container such that the second container has a higher pressure that the first container, whereby, upon opening the second reaction component in the inner pouch, the second component is driven into the outer pouch to react with the first reaction component; and
pulling on the pull end to cause the line to open the second container.

12. The method of claim 11, wherein the pressure differential is caused by a vacuum inside the first container.

13. The method of claim 12, wherein the amount of vacuum in the first container is sufficient to give a pressure of from about 8 to 13 psi.

14. The method of claim 11, wherein the pressure differential is caused by an elevated pressure inside the second container.

15. The method of claim 11, wherein the second container is formed from a material capable of being torn by pressure of the line on the material.

16. The method of claim 15, wherein the material is a foil type material.

17. The method of claim 11, wherein the second container has a periphery extending out from the container and not in communication with the contents of the second container, the periphery including at least one perforation through which the line is placed such that pulling on the pull end causes the line to penetrate the container.

18. The method of claim 11, wherein the actuation agent is water and the heat generating material is crystalline calcium oxide.

19. The method of claim 18, which further includes powdered zeolite admixed therein with the calcium oxide.

20. The method of claim 19, wherein the ratio of calcium oxide to powdered zeolite is 2:1 and the ratio of the solids to the volume of water is about 3:4.
